(19) United States
(12) Patent Application Publication
(10) Pub. No.: US 2023/0291339 A1
(43) Pub. Date: Sep. 14, 2023

(54) Active Electric ESS

(71) Applicant: Punch Flybrid Limited, Silverstone (GB)

(72) Inventors: Andrew Deakin, Silverstone (GB); Jean Paul Zammit, Silverstone (GB)

(21) Appl. No.: 18/018,414

(22) PCT Filed: Jul. 23, 2021
(86) PCT No.: PCT/GB2021/051905

§ 371 Date: Jan. 27, 2023

(30) Foreign Application Priority Data
Jul. 27, 2020 (GB) 2011600.0

(51) Int. Cl. H02P 9/02; H02K 7/02; H02J 1/00

(52) U.S. Cl. CPC H02P 9/02; H02K 7/025; H02J 1/00

(57) ABSTRACT

An AC generating system having a power source, a controller, and an energy storage subsystem including a rotatable flywheel connected to an electrical machine which is operable to convert flywheel rotation into electrical energy and vice versa, the energy storage subsystem to transfers energy from or to the generating to maintain a target state of charge of the flywheel. The controller is arranged to monitor the AC frequency of the output power from the power source and to feed in power or extract power from the energy storage subsystem into the generating system to counteract relatively short term frequency errors due to changes in demanded load on the AC generating system. Or the power source and energy storage subsystem may be interconnected via a DC bus, and wherein the controller is arranged to monitor the DC power or voltage on the bus against a target power.

### CROSS-REFERENCE TO RELATED APPLICATIONS

The present application claims priority to PCT International Patent Application No. PCT/GB2021/051905, filed Jul. 23, 2021, and Great Britain Patent Application No. 2011600.0, filed on Jul. 27, 2020, the disclosures of which are incorporated herein by reference.

### STATEMENT RE: FEDERALLY SPONSORED RESEARCH/DEVELOPMENT

Not Applicable

### BACKGROUND

This invention relates to power generation control suitable for use in a micro grid installation.

Micro grids are local power networks which are sometimes or always disconnected from the main electrical power grid. They may receive power generated from a variety of sources including diesel and gas generators and renewable energy sources such as wind, solar and wave power. A diesel or gas generator, or even a gas turbine can be used as the primary power source, the only power source, or as a back-up when other forms of energy are not available. A suitable micro grid may be a single-phase, or 3-phase arrangement.

Power generation devices such as generators are typically sized to deal with the worst case electrical loads on the micro grid which may be due to a steady state base load or short term transient loads.

Transient loads can be applied to the micro grid due to, for example, electrical motors starting up to drive things like oil pumps, pumps, cranes, or other equipment or machines. These loads may for example, be found in factories which have cyclic or sporadic loads.

When a transient load is applied to a micro grid where the majority of power is generated by a diesel or gas generator or a gas turbine, the micro grid electrical frequency will be disturbed until the power generation device achieves a power output that matches the new power demand. In order to achieve the required power demand, the power generation device must generate the required power whilst controlling its rotational speed to the target speed and thus electrical frequency. When a transient load is applied, the power generation device, e.g., genset, has to increase the power that is generated. Due to the time required to respond, kinetic energy from the rotating components is utilised until the power generation device can supply the new steady state power. This results in a temporary speed change of the power generation device and a frequency change of the electrical output. This change in frequency depends on the size of the transient load, the rotational inertia of the power generation device and how quickly the power generation device's control and fueling system can react to the change in demanded power.

When transient loads are significant, for example 20% or more of the typical base load, a power generation device with a rating significantly higher than the maximum load or average load will have to be selected in order to ensure that the micro grid frequency remains sufficiently stable for all devices that are connected to the micro grid to function correctly and robustly. For a given transient load, a bigger power generation device maintains more stable frequency control by having more kinetic energy in the relatively heavier rotating components; for example, in the case of a reciprocating piston diesel engine, the engine crank, pistons and flywheel will usually be larger and heavier and therefore have a larger rotational inertia for a larger engine. This means that the percentage of transient load step is smaller relative to the generator size, with a consequent reduction in the frequency change with transient load.

A diesel generator will typically consume around 220 grams of diesel per kWh of energy that is generated if it is running above 70% of its rated load. If the load is reduced to 20% of the rated load, by using an oversized diesel generator, then this consumption can increase to around 300 grams of diesel per kWh of energy that is generated, representing a 36% increase in fuel consumption. This change in efficiency is largely due to the diesel generator losses due to friction being generally the same regardless of power output but scaling with size of the engine. Thus, for a larger engine at lower power output a larger percentage of fuel used is required to overcome the frictional losses, compared to a smaller engine at the same power output.

A solution that enables a smaller power generation device to operate at a higher average base load, which is configured to deal with transient loads that it might not normally cope with, has significant potential to reduce the fuel consumption when compared to using a much larger power generation device to produce the same amount of electrical energy operating at a much reduced percentage of its rated load.

In order to use a smaller power generation device, a system is required that can supplement the power generation device and which can generate high power in a short period of time. This system can, for example, work for a short period of time to overcome a short duration load, such as a large motor starting which may only last a few seconds or less than one second. It may also or instead, assist the power generation device whilst it transitions from one load point to another load point and thus enabling that to occur over a few seconds, or less than one second. or to load-level a cyclic or random variation in power by assisting the power generation device when the power requirement is high, and adding load when the power requirement is low. There could be combinations of transitional and transient loads that need to be overcome.

One particular case is when a large motor is turned on as a direct on line connection, the in-rush current to the motor can be very high, perhaps eight time the normal maximum current. In this case the line voltage can see a very significant disturbance. Preferably a star delta starter would be used, to reduce the current, but this may not be available.

Another aspect of motors which can power pumps and other machines is that they typically run at a power factor <0.8. This means that the 3 phase current supplied to the micro grid which relates to the apparent power can be significantly higher than the current required to do useful work; the active power due to the motor absorbing a lot of reactive power. As the motor starts up, this current can result in excessive voltage drops which can result in the generator requiring further oversizing.

### BRIEF SUMMARY

US2018/069399A1 (Beacon Power) describes a method of controlling AC frequency of electrical power which has one or more electrical loads, one or more power sources and an energy storage sub-system which includes one or more flywheel storage systems. It is based on controlling the output of the flywheel system due to a change of grid power (large grids) over several minutes and does not respond directly to a change in frequency. The control system uses the measured loads and generated power on the grid to determine if power should be supplied from the flywheel storage system to make up a difference, or taken from the grid to absorb a difference if an excess of power is being generated.

In accordance with a first aspect of the invention, there is provided a micro grid generating system having a power source, a controller, and an energy storage subsystem including a rotatable flywheel connected to an electrical machine comprising a motor and regenerative inverter drive and which is operable to convert flywheel rotation into electrical energy and vice versa, the microgrid being coupleable to an electrical load which creates a demanded load which varies over time, the controller being arranged to cause the energy storage subsystem to transfer energy from or to the generating system via the electrical machine, to maintain a target state of charge of the flywheel, and wherein the power source is an AC source and the electrical machine is electrically connected to the power source and the controller is arranged to monitor the AC frequency of the output power from the AC power source and to feed in power or extract power from the energy storage subsystem via the electrical machine, into the generating system to reduce the AC frequency variation by counteracting frequency errors within a few tens of milliseconds, due to changes in the demanded load on the micro grid generating system, by exchanging energy between the flywheel and the electrical machine, and wherein the controller is operable to achieve its target power from the flywheel in <1 sec, more preferably in <0.1 sec and most preferably in <0.05 seconds.

In a second aspect, the invention provides, a controller arranged to be coupled to a micro grid generating system having an energy storage subsystem including a rotatable flywheel connected to an electrical machine comprising a motor and regenerative inverter drive and which is operable to convert flywheel rotation into electrical energy and vice versa, and to an AC power source using an electrical bus between the electrical machine and the AC power source, the microgrid being coupleable to an electrical load which creates a demanded load which varies over time, and the controller being arranged to cause the energy storage subsystem to transfer energy from or to the generating system via the electrical machine, to maintain a target state of charge of the flywheel as load on the system varies over time and wherein the controller is further arranged to monitor the AC frequency of the output power from the generating system and to respond within a few tens of milliseconds to feed in power or extract power from the energy storage subsystem into the generating system to counteract frequency errors, such as those caused by transient loads on the power source, and wherein the controller is operable to achieve its target power from the flywheel in <1 sec, more preferably in <0.1 sec and most preferably in <0.05 seconds. This controller may form a component part of the first aspect above, and may include any combination of the optional features set out in the description, or claims which depend from claim one, below.

In a third aspect, the invention provides a controller arranged to be coupled to a generating system having an energy storage subsystem including a rotatable flywheel connected to an electrical machine which is operable to convert flywheel rotation into electrical energy and vice versa, and to a power source using a DC electrical bus between the electrical machine and the power source, the controller being arranged to cause the energy storage subsystem to transfer energy from or to the generating system via the electrical machine, to maintain a target state of charge of the flywheel, and wherein the controller is arranged to monitor the DC power or voltage on the bus against a target power or voltage and to feed in power or extract power from the energy storage subsystem into the generating system to counteract power and/or voltage errors on the DC bus, and wherein the controller is operable to achieve its target power from the flywheel in <1 sec, more preferably in <0.1 sec and most preferably in <0.05 seconds. In this case, it will be noted that a DC bus is used to connect the power source and the energy storage subsystem. In other respects, the third aspect is similar to the first and second aspects, and the skilled person will appreciate that the combinations of features discussed in connection with those aspects is applicable also to this third aspect.

In a further aspect, the invention provides a method of controlling an energy storage subsystem comprising a rotatable flywheel connected to an electrical machine comprising a motor and regenerative inverter drive and which is operable to convert flywheel rotation into electrical energy and vice versa, the electrical machine being coupleable via a bus into a micro grid which is also connected to a power source, the method comprising the steps of causing the energy storage subsystem to transfer energy from or to a bus, via the electrical machine, to maintain a target state of charge of the flywheel as load on the system varies over time, and wherein the micro grid is an AC micro grid and the energy storage subsystem is caused to monitor the AC frequency on the micro grid and to feed in power or extract power from the energy storage subsystem, via the electrical machine and the bus into the micro grid to counteract frequency errors and wherein the energy storage subsystem is controlled to achieve its target power from the flywheel in <1 sec, more preferably in <0.1 sec and most preferably in <0.05 seconds.

In a further aspect, the invention provides an AC generating system having a power source, a controller, and an energy storage subsystem including a rotatable flywheel connected to an electrical machine which is operable to convert flywheel rotation into electrical energy and vice versa, the controller being arranged in a start-up phase, to synchronise the electrical machine and flywheel with the power source using a regenerative drive which controls the flow of power, and their respective frequencies, between the power source and the electrical machine and then once synchronisation is achieved, entering a bypass state by bypassing the regenerative drive to connect the output of the electrical machine directly to the output of the power source.

The invention also includes data processing apparatus and computer program product aspects.

### BRIEF DESCRIPTION OF THE DRAWINGS

Embodiments of the invention will now be described by way of example, with reference to the drawings in which:

FIG. 1 is a schematic block diagram of a passive Energy Storage System;

FIG. 2 is a schematic diagram of an Energy Storage System with a genset and micro grid connection;

FIG. 3 is a schematic diagram of an Energy Storage System with a genset and micro grid connection and brake systems;

FIG. 4 is a schematic diagram of an Energy Storage System with a genset and micro grid connection showing a DC bus;

FIG. 5 is a schematic diagram of an Energy Storage System with a genset and micro grid connection and drive bypass;

FIG. 6 is a flowchart of a control system; and

FIG. 7 is a schematic diagram of an Energy Storage System with a genset and 3-phase micro grid connection.

### DETAILED DESCRIPTION

In summary, the Energy Storage sub-System (ESS) described below, ideally meets several challenges:
How to control the ESS power delivery to minimise variation of power demand from an electrical power source e.g., a genset
How to minimise harmful emissions from hydrocarbon based generating devices
How to minimise variation in micro grid frequency
How to minimise variation in micro grid voltage
How to enable large, short duration electrical loads to be started with minimum energy storage.

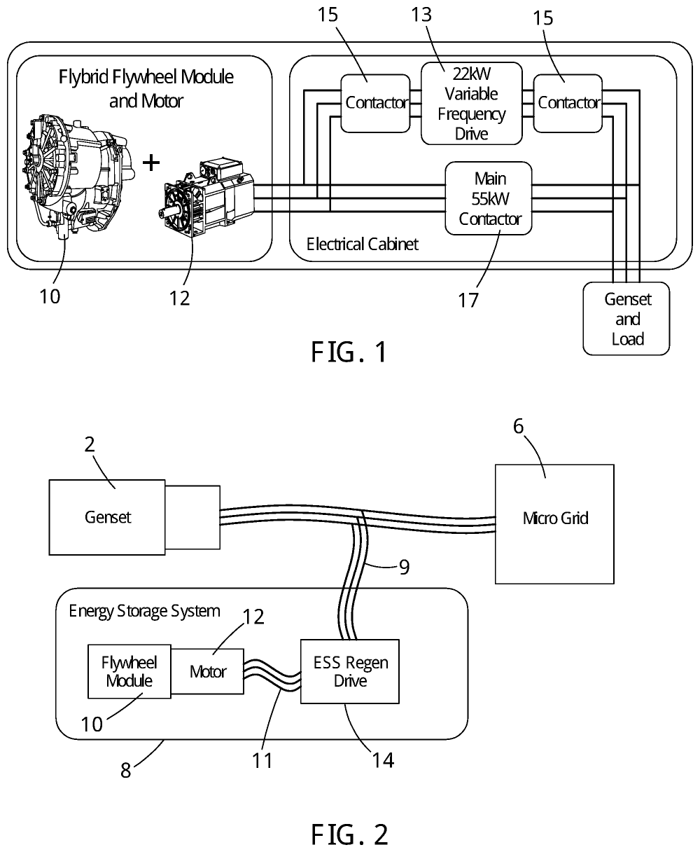

With reference to FIG. 1, one simple option is to create a passive system in which a flywheel 10 is connected to the local grid via an electric motor 12. For start-up, the motor and flywheel is synchronised with the micro grid using a drive connected to the micro grid and then once synchronisation is achieved, bypassing the drive. This is achieved using a relatively low power, variable frequency drive 13 inserted into the circuit between the micro grid and the motor, using contactors 15 in order to allow the flywheel 12 to be spun up to speed using micro grid power, and synchronised with the micro grid frequency when the system is initialised. This can also be used in normal steady state operation, to keep the motor 12 synchronised. But more typically, once synchronised, the motor is connected directly to the micro grid as explained below. In this case if the grid frequency varies, the motor and flywheel is connected directly to the micro grid using a higher power contactor 17 and energy is directly taken or put into the flywheel because it is accelerated. Effectively such a system is increasing the kinetic energy store of the genset without necessarily adding significant fuel inefficiencies in the same way as oversizing the power generating device.

However, there is no independent control over the rate at which energy is removed or added to the flywheel 10 and thus such a system can interact with other devices that are controlling the frequency, resulting in control instability or oscillations.

One advantage of this is that for very large step changes in load which may occur, for example, when starting a pump or motor, only the flywheel-connected motor capacity will limit the amount of power that is available to assist the start event, and not the capacity of any variable frequency electrical drive 13.

This can be improved as described below.

With reference to FIG. 2, an electrical generator is coupled to an Internal Combustion (IC) engine and this genset combination 2 is operable to create an AC supply (for example, 110V at 60 Hz or 220V at 50 Hz, or more usually, 3-phase 480V at 60 Hz, or 400V at 50 Hz) to feed into a micro grid 6 to support electrical loads on the micro grid such as houses, factories and equipment such as electrical motors, which drive things like cranes, pumps and other equipment or machines. The AC supply may come from other sources such as renewable sources such as wind or water turbines and/or solar, instead of, or in addition, to the genset. The skilled person will appreciate that other frequencies, voltage levels and/or numbers of phases are also possible.

An energy storage device (ESS) 8 is electrically connected to the genset 2 and the micro grid 6. The ESS may be a flywheel 10 such as a flywheel in a vacuum or partial vacuum either directly connected to electric motor/generator 12, or connected to an electric motor/generator via a gear ratio/transmission (not shown). The motor/generator 12 could be an induction or permanent magnet motor/generator, and its electrical connection is fed into the micro grid in parallel with the output from the genset 8 via a regenerative drive 14 so that current can flow in either direction—into or out of the motor 12. In this way, the ESS 8 can receive power from the micro grid 6 or supply power to the micro grid 6 with consequent respective increases or decreases in the rotational speed, and therefore the energy stored, in the flywheel 10. Thus, the regenerative drive 14 can pass electrical energy to the motor 12 and can take it from the motor thus charging and discharging the flywheel 10. As this happens and the flywheel speed varies, the frequency of the connection between the regen drive 14 and the motor 12 (coupled to the flywheel either directly or via gearbox), will vary significantly with motor speed whereas the frequency of the genset will intentionally remain relatively constant. The regenerative drive 14 includes a controller, as described in more detail below, which controls the flow of power, and their respective frequencies, between the micro grid 6 and the ESS 8.

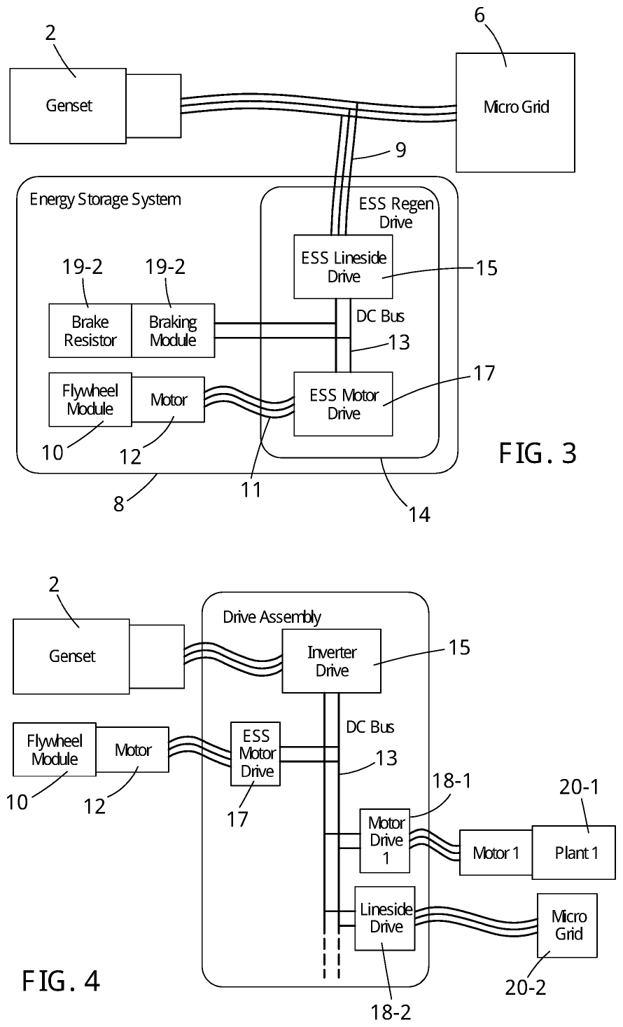

With reference to FIG. 3, the ESS regen drive 14 has a lineside connection 9 for coupling to the normal AC connection between the genset 2 and the micro grid 6, an AC motor connection 11 and an internal DC bus 13. There is an inverter 15 that connects the lineside micro grid three-phase grid 9 to the DC bus 13, and this is termed an “ESS Lineside Drive”. There is also an inverter 17 that connects the DC bus 13 to the flywheel module motor 12, and this termed an “ESS Motor Drive”.

It is optionally possible to add additional components to the DC bus 13 which is contained within the inverter drive. One such component may be a braking module 19-1 such as a braking resistor 19-2 or other device which can be used to dissipate excess energy that cannot be absorbed by the ESS Flywheel Module 8 firstly because the flywheel is at maximum state of charge, and/or secondly because the electrical power to be absorbed exceeds the capacity of the ESS motor drive 17 or the flywheel motor 12. In alternative arrangements, these components could be added to the motor connection 11.

With reference to FIG. 4, in some implementations, some or all of the micro grid 6 may be supplied directly from the DC bus 13, where electric motor drive 18-1, or lineside drive 18-2 for plant 20-1, or micro grid 20-2 are connected directly to the common DC bus. In this arrangement, the control system can be arranged to monitor genset frequency and/or or DC bus total power.

This can power multiple motors from the DC bus or generate a more general 3 phase supply to supply a local grid 20-2 in the same way that a genset would normally supply the local grid. Benefits of this approach is that the genset is load levelled at the DC Bus and the genset engine can also be run at different speeds to further improve efficiency, for example low speed at low loads.

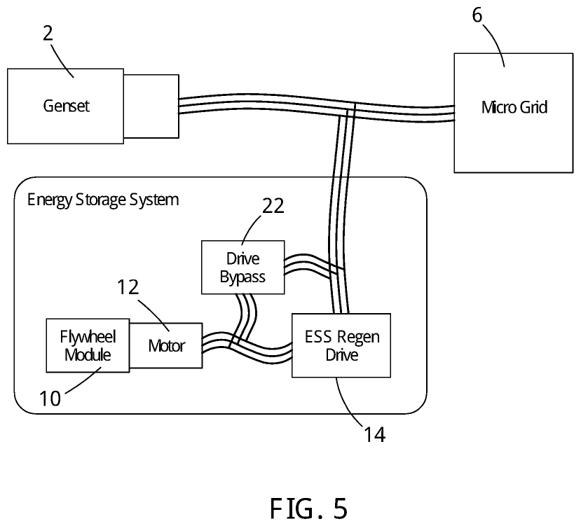

With reference to FIG. 5, when the transient loads from the micro grid 6 are very high and can be predicted, e.g. a known motor start-up event is going to occur, the ESS Regen drive 14 can be used to synchronise the motor frequency with the genset frequency in advance, and can then be bypassed using a bypass 22, such that when the genset/micro grid frequency drops, a higher power than can be sustained by the ESS Regen Drive 14 can be pulled directly from the motor 12, effectively operating like the passive system of FIG. 1 when in bypass mode.

The ESS 8 may be a separate device simply needing an electrical connection into the AC or DC bus, or it may be structurally integrated into the power generation device housing or another device on the micro grid. The controller for the regen drive 14 may be integral the drive 14, or it may be a separate ECU that communicates with the regen drive 14.

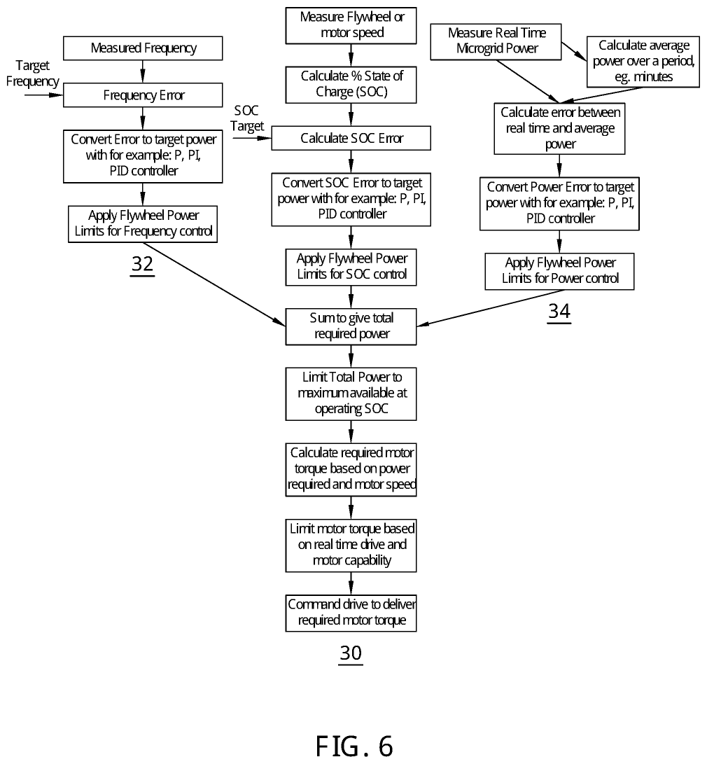

With reference also to FIG. 6, micro grid frequency is measured and/or total load on the micro grid is measured between the genset+ESS and the load, and the ESS is controlled with the aim of maintaining a stable instantaneous micro grid frequency with the combined outputs of the genset and ESS.

FIG. 6 shows three control loops which are expected to cooperate with a separate genset control scheme which will, over time, allow the genset 4, 2 to reach a steady state, satisfactory output without assistance from the ESS. As noted above, the ESS is intended to deal with short-term disruptions to the micro grid. If the genset, cannot eventually achieve a satisfactory output, then it is probably incorrectly sized, or the micro grid is overloaded.

In the central column of the Figure is a loop 30 which maintains the flywheel at a target state of charge (SOC). This control loop is used to manage the energy in the flywheel. This uses a closed loop which is controlled to slowly return the flywheel to its target state of charge (SOC) after any event. This may be disabled or limited in a case where the genset is close to maximum, or at maximum load after a transient event.

Optionally the controller 30 can be used to target a higher SOC before a known event occurs, for example in the case that an operator is going to start a motor which could exceed the capabilities of the genset. A pre-charge to a high SOC will maximise the energy available in order to sustain a high power transient event for the maximum time.

When the flywheel gets close to the limit of SOC it will have power limited with a roll-off in the power that is delivered.

A primary controller 32 is used to control the ESS based on the micro grid frequency or instantaneous power. When micro grid frequency is reduced, or micro grid load is increased, the flywheel is controlled to discharge in order to support the power generation device (for example a diesel generator which can be referred to as a genset) allowing more time for the power generation device 4 to achieve the new target load, or where a load is sustained for a short period, peak lopping the load with electrical energy from flywheel system until the load is removed or returned to the base load. The power requirement to stabilise frequency is added into the SOC loop 30 after the SOC error has been assessed to arrive at a total power requirement of the flywheel. Typically, the SOC loop 30 will have a longer time constant than the loop 32 so that the instantaneous requirement to deal with a frequency error will in most cases, override the longer term requirement to keep the flywheel charged at a target level.

The system is generally fast acting and will deliver energy by achieving its target power from the flywheel in <1 sec and typically <0.1 sec and preferentially <0.05 seconds. To put this into context, the flywheel ESS described here can respond to transient loads around >1000 kW/sec, 2000 kW/Sec or 2500 KW/sec for an 80 kW system whereas a genset would typically need to have an output of >1000 kW to respond at that rate.

For transient loads, it may be preferable to maintain a relatively small error in frequency for a short period of time, for example up to 2 or 3 Hz, which enables the genset to react to the error in the normal way and achieve the target genset power in a relatively short period of time, for example less than 10 or preferentially less than 2 seconds. This is achieved by adjusting the parameters in the loop 32 to enable a controlled error in frequency during transient loads, such that the genset control loop is activated and responds in parallel to the ESS. In this way, the control loop 32 maintains an error so that the genset is forced to respond reasonably quickly and so that the flywheel doesn't run out of energy correcting these small errors. In this example, the loop 32 acts with high power, so that when it does respond outside the acceptable small error, it responds strongly, in order to prevent the frequency deviating beyond this small error band where possible.

For peak lopping, it may be preferential to de-tune the genset control such that it delivers power at a steady state condition with relatively slow adjustments, thus enabling the flywheel system to cover the transient events more effectively. The genset power target will be determined by measuring a longer term average power, perhaps over the last few seconds to a minute or perhaps even longer. Interaction in this mode may be achieved using the third loop 34 which carries a slow moving average (typically over several minutes) based on historical values of the genset contribution as a baseline for ESS intervention. This will be particularly suitable also in systems in which the genset control loop reacts very quickly and perhaps cannot be modified, in order to avoid the genset and ESS loops causing instability between them by reacting to the effects of each other.

The primary controller 32 may be a closed loop controlled based on for example, a P, PI, PID with one or more sets of gains depending on frequency or power level. This control loop may also be adapted to include measurements of real and reactive load requirements and taking the control strategies described in more detail below. This is particularly applicable where the power factor of the load is significantly below 1, such as for an induction motor during startup.

There can optionally be a deadband (in the range <1 Hz and maybe <0.1 Hz) such that when the genset is controlling the output frequency to the normal frequency, e.g., 50 or 60 Hz, there is no interaction with the genset and the Flywheel System such that the normal genset controller can be used to control micro grid frequency under normal steady state conditions.

The controller can be in a PLC, a dedicated Electronic Control Unit (ECU) or part of the control system of another component, for example, the motor drive or if integrated into the genset, in the genset controller or any other device that can modulate the drive 12 output.

For very high transient loads, for example starting a motor direct on line (DoL), it may be preferential to bypass the drive altogether during this event. This would mean synchronising the input and output of the drive and then connecting these directly through a contactor. During a DoL motor start, the energy would be pulled out of the motor directly enabling higher powers for a short duration before reverting back to control through the drive.

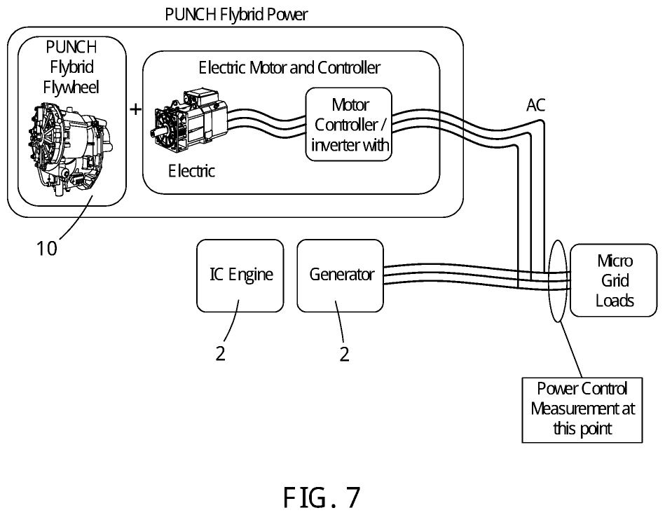

Also, for high transient loads, it may be appropriate to monitor the 3 phase micro grid voltage, as shown in FIG. 7, as this will reduce very rapidly and more quickly than the genset frequency when an instantaneous load is applied to the grid, for example as a (Direct on line) DoL induction motor is connected. The monitoring or measurement of power, may be made at the point that the ESS and Genset come together and are connected into the microgrid loads, as shown in the Figure. Monitoring voltage may improve response time compared with frequency monitoring. The error in voltage between the target and actual voltage can be monitored and the flywheel can be discharged or charged to support the change in voltage.

Additionally, it can be possible for the genset to be at a frequency below the target frequency, but the 3-phase line voltage or the DC bus voltage in the inverter drive to be above the target voltage. This can happen when for example a DoL induction motor is started and suddenly reaches its operating speed and the power to drive it reduces very quickly. If the flywheel energy is being added to the local grid to recover the voltage and the genset is also recovering its speed, then excessive energy can be put into the micro grid. It may therefore be necessary to monitor the voltage for over voltage events on the 3 phase voltage or drive's DC bus such that the additional electrical power from the flywheel is either reduced or removed immediately. This additional strategy may be required to protect the drive, genset and other items on the local grid from damage due to over voltage events.

For high transient loads, particularly where the power factor of the load is significantly below 1, perhaps 0.5-0.8, such as for an induction motor during start-up, there is a significant reactive current that is drawn which can cause excessive voltage drops.

The previous description assumes that only real power is supplied by the ESS when the controller requests power in kW.

This can result in the generator operating at or close to the correct frequency, but the voltage error can still be excessive as the alternator can struggle to achieve the voltage target.

Supplying real power can correct the frequency error as that is required to accelerate the inertia of the engine back to the correct operating speed, or at least to stop it decelerating until the engine can provide sufficient torque to re-accelerate the engine. In addition, reactive power can be supplied to support the voltage, enabling the voltage droop to be reduced without deploying too much real power in the case that a load with low power factor is applied.

A control strategy can be used which deploys real power to compensate for frequency errors by generating real power as a function of the frequency error and reactive power to compensate for voltage errors by delivering reactive power as a function of the voltage error especially when the voltage error is exceeds a certain level. Both controllers can be active simultaneously.

It can also be the case that the voltage recovers quickly at the end of a transient event. As an example, this can happen as a DoL motor achieves synchronisation with the micro grid and there is no required start-up current. This case can be detected by the frequency being low but the voltage recovering rapidly to the target level with the potential to result in an over-voltage situation. In this case, the genset engine will recover to normal operating speed without assistance from the ESS and power from the ESS can be reduced as required by the controller ensuring that the voltage does not exceed any maximum threshold.

In addition to control based purely on the voltage and frequency, the control can be based on power demanded from the plant as described earlier. This can be achieved by using a power meter with a fast response to measure the power demand. In this case the device used to measure the power can determine whether real or reactive power is being demanded by the load and the ESS controller can directly control the real and reactive power supplied during the transient load event (e.g., an event of less than 5 seconds, and preferably with a duration between 50 ms and 5 sec) to limit and smooth the loading on the generator thus minimising voltage and frequency drops. The reactive power can be supplied proportionately more than the real power in order to provide better voltage support if required.

Furthermore, if the plant being driven by a generator which is demanding excessive reactive power and especially in the case that the reactive power is steady state, particularly in the case where it may exceed the maximum current of the generator due to a poor power factor (<0.7), the drive electronics (inverter) of the ESS can be controlled to provide continuous reactive power in order to reduce the reactive power and thus electrical current drawn from the generator. The drive can be arranged to supply continuous reactive power as that requires no real energy. This is achievable even though the drive, has a limited amount of real power that can be supplied, due to the limited energy stored in the flywheel.

To achieve this, the current may be measured at the supply to the load, as shown in FIG. 7, but could be measured at the generator output as the supply from the ESS is known. Power is calculated from the voltage (measured in the ESS as voltage is essentially the same throughout) and the current supplied to the load real/active power, apparent power and reactive power can be calculated by standard methods from the voltage and current and the relative phase of both.

For this application the power is ideally calculated in <100 ms and preferably in <50 ms. There are very few standard electrical power meters that can achieve this. The calculation can be performed by a dedicated meter using internal 3 phase voltage measurements and 3 phase current measurements typically interfaced through current transformers, or within the main controller using the required signal conditioning to enable the voltages and currents measurements to be available to the main controller.

The control implementations are as follows:
1. Frequency is measured and real power is supplied as a function of the frequency error
2. Frequency is measured and the power factor of the load is known so real and reactive power are supplied from the ESS with a pre-determined ratio. It may be advantageous to supply more reactive power to minimise the voltage drop
3. Frequency is measured and voltage is measured. Real power is supplied as a function of frequency and reactive power is supplied as a function of voltage
4. During a transient phase, the active/real power is measured. The supplied real power can be a function of the transient real power which can be determined by using a high pass filter where the high pass filter is set to determine the transient power over approximately the last second. At the same time reactive power can be supplied as a function of the actual reactive power required by the load.
5. When the power factor of the load is poor, it is possible to use the ESS inverter to continuously supply reactive current in order to reduce the reactive current and therefore total current load on the alternator of the generator. The reactive current delivered can be controlled as a function of the reactive current demanded by the load.
6. There are other combinations of measuring real and reactive power, voltage and frequency as described in 1-5 which can be used to control the real and reactive power supplied by the ESS.

Preferably, in all of these cases, if certain limits are exceeded, for example the micro grid voltage goes outside of pre-determined limits, the real power can be reduced to prevent the limit being exceeded. Reactive power can also be used to prevent such limit transgressions.

This arrangement can also be used on a diesel electric powertrain on a machine, not limited to a vehicle, a train, cranes, ships or an excavator where an engine, e.g., a diesel engine is used with a generator to provide electrical power to a DC bus on the machine and the vehicle's motors are used to drive the vehicle or actuate moving components on the machine. It might also be used in a micro grid which mainly uses renewable sources but has an IC engine backup, to cover engine start delay if for example the sun goes in for a PV array, or the wind dies. It could also be used for dynamic load levelling of a wind turbine to limit power output and smooth power delivery. Thus, it will be appreciated that the primary power source need not be an internal combustion engine based genset.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. A generating system having a power source in a micro grid, a controller, and an energy storage subsystem including a rotatable flywheel connected to an electrical machine comprising a motor and regenerative inverter drive and which is operable to convert flywheel rotation into electrical energy and vice versa, the electrical machine being connected to the micro grid, the controller being arranged to implement a control loop to cause the energy storage subsystem to transfer energy from or to the micro grid via the electrical machine, to maintain a target state of charge of the flywheel, and wherein the power source is an AC source and the electrical machine is electrically connected to the power source and the controller implements a frequency control loop, such as a P, PI or PID loop and which is arranged to determine a frequency error in the AC frequency of the output power from the AC power source against a target frequency, to convert the frequency error into a first target power and to feed in power or extract power from the energy storage subsystem via the electrical machine, into the micro grid and thereby to reduce variation of the AC frequency by counteracting the frequency error and within a loop response time of a plurality of tens of milliseconds, due to changes in demanded load on the generating system, by exchanging energy between the flywheel and the electrical machine.

2. A generating system as claimed in claim 1, wherein the controller is arranged to monitor the output voltage of the generating system and cause the energy storage subsystem to feed in power or extract power from the energy storage subsystem into the micro grid to counteract voltage errors using a voltage control loop.

3. A generating system as claimed in claim 1, wherein the controller implements a power control loop which calculates average microgrid power over a plurality of minutes, calculates an error against real-time microgrid power and converts the power error into a second target power with a loop such as a P, PI or PID loop and the loop being configured to achieve its target feed in power or power extraction to converge on the second target power in <1 sec, more preferably in <0.1 sec and most preferably in <0.05 seconds, and wherein the target power from the first and second loops is summed to give an instantaneous power requirement from the flywheel.

4. A generating system as claimed in claim 1, wherein the controller is arranged to monitor average power in the generating system over a time period, such as over a plurality of minutes, and to generate an average power value over that time period, and using the average power value as a target power value, to cause, with a quicker response rate than the period over which the average power value is monitored, such as over a period less than a second, the energy storage subsystem to transfer energy from or to the micro grid to compensate for dynamic changes in load relative to the target power value.

5. A generating system as claimed in claim 1, wherein the frequency control loop is arranged to respond at a faster rate than the state of charge control loop.

6. A generating system as claimed in any of claim 1, in which the power source and energy storage subsystem are interconnected via a DC bus, and wherein the controller is arranged to monitor the DC power or voltage on the bus against a target DC power or voltage power and to feed in power or extract power from the energy storage subsystem into the micro grid to counteract power and/or voltage errors on the DC bus.

7. A generating system as claimed in claim 6, wherein the DC bus carries directly connected loads.

8. A controller arranged to be coupled to the generating system of claim 1.

9. A controller arranged to be coupled to a generating system having an energy storage subsystem including a rotatable flywheel connected to an electrical machine which is operable to convert flywheel rotation into electrical energy and vice versa, and to a power source using a DC electrical bus between the electrical machine and the power source, the controller being arranged to cause the energy storage subsystem to transfer energy from or to the bus via the electrical machine, to maintain a target state of charge of the flywheel, and wherein the controller is arranged to monitor the DC power or voltage on the bus against a target power or voltage by implementing a power control loop which calculates average bus power or voltage over a plurality of minutes, calculates an error against real-time bus power or voltage and converts the power or voltage error into a target power with a loop such as a P, PI or PID loop and the loop being configured and to feed in power or extract power from the energy storage subsystem into the bus to counteract the power and/or voltage errors on the DC bus, and wherein the power control loop (34) is operable to achieve its target feed in power or power extraction in <1 sec, more preferably in <0.1 sec and most preferably in <0.05 seconds.

10. A controller as claimed in claim 9, wherein the DC bus carries directly connected loads.

11. A method of controlling an energy storage subsystem comprising a rotatable flywheel connected to an electrical machine comprising a motor and regenerative inverter drive and which is operable to convert flywheel rotation into electrical energy and vice versa, the electrical machine being coupleable via a bus into a micro grid which is also connected to a power source, the method comprising the steps of causing the energy storage subsystem to transfer energy from or to the bus, via the electrical machine, to maintain a target state of charge of the flywheel as load on the system varies over time, by implementing a state of charge control loop, and wherein the micro grid is an AC micro grid and the energy storage subsystem is caused to implement a frequency control loop, such as a P, PI or PID loop and which is arranged to determine a frequency error in the AC frequency on the micro grid against a target frequency, to convert the frequency error into a first target power and to feed in power or extract power from the energy storage subsystem, via the electrical machine and the bus into the micro grid to converge on the first target power and thus to counteract frequency errors

12. A method as claimed in claim 11, wherein the energy storage subsystem is also controlled by a power control loop which calculates average microgrid power over a plurality of minutes, calculates an error against real-time microgrid power and converts the power error into a second target power with a loop such as a P, PI or PID loop and is configured to achieve its target feed in power or power from the flywheel to converge on the second target power in <1 sec, more preferably in <0.1 sec and most preferably in <0.05 seconds.

13. A method as claimed in claim 11, comprising the steps of monitoring the output voltage on the micro grid and causing the energy storage subsystem to feed in power or extract power from the energy storage subsystem into the micro grid to counteract voltage errors using a voltage control loop that reacts more quickly than the frequency control loop.

14. A method as claimed in any of claim 11, including monitoring average power in the micro grid over a time period, such as over a plurality of minutes, and generating an average power value over that time period, and using the average power value as a target power value, to cause, with a quicker response rate than the period over which the average power value is monitored, such as over a period less than a second, the energy storage subsystem to transfer energy from or to the micro grid to maintain the micro grid at the target power value.

15. A method as claimed in any of claim 11, wherein the frequency control loop is arranged to respond at a faster rate than the state of charge control loop.

16. A method as claimed in a claim 12, in which the power source and energy storage subsystem are interconnected via a DC bus, and wherein the method includes monitoring the DC power or voltage on the bus against a target power and feeding in power or extracting power from the energy storage subsystem into the generating system to counteract power and/or voltage errors on the DC bus.

17. A method as claimed in claim 16, wherein the DC bus carries directly connected loads.

18. A data-processing apparatus for carrying out the steps of the method of claim 11.

19. A computer program product comprising instructions which, when the program is executed by a computer, cause the computer to carry out the steps of the method of any of claim 11.
